(19) United States
(12) Patent Application Publication
(10) Pub. No.: US 2010/0236077 A1
(43) Pub. Date: Sep. 23, 2010

(54) Personal weapon

(76) Inventors: Patricia A. Shirey, Warriors Mark, PA (US); Walter F. Shirey, Warriors Mark, PA (US)

Correspondence Address: LITMAN LAW OFFICES, LTD., POST OFFICE BOX 41200, SOUTH STATION, ARLINGTON, VA, 22204, US

(21) Appl. No.: 12/656,317

(22) Filed: Jan. 25, 2010

Related U.S. Application Data
(60) Provisional application No. 61/202,638, filed on Mar. 20, 2009.

(51) Int. Cl. B26B 1/02; A41D 19/00

(52) U.S. Cl. 30/152; 2/160

(57) ABSTRACT

The personal weapon includes a base and blade support pivotally attached to the base, with a plurality of blades extending from the blade support. The assembly is installed across the upper palm and adjacent bases of the fingers of a glove, with backing plates providing additional reinforcement for the assembly. The blades extend selectively as the palm is opened and the fingers extended, with the blades retracting into slots in the base when the fingers are closed over the palm. The device extends only across the second through fourth fingers, leaving the index finger free for e.g., firearm trigger actuation, etc. independent of blade deployment. A thumb-actuated safety is also provided to lock the blades in their retracted positions. The glove may be fingerless or partially fingered, or may include complete, fully enclosed fingers.

### CROSS-REFERENCE TO RELATED APPLICATION

This application claims the benefit of U.S. Provisional Patent Application Ser. No. 61/202,638, filed Mar. 20, 2009.

### BACKGROUND OF THE INVENTION

1. Field of the Invention

The present invention relates generally to bladed, handheld weapons and the like. More particularly, the present invention is a personal weapon having a plurality of retractable blades extending from the palm area of a fingerless glove or glove with truncated fingers.

2. Description of the Related Art

Handheld personal weapons, e.g., knives and the like, have been used for personal protection and in hand-to-hand combat since the earliest times. Such bladed weapons provide great utility for other purposes as well, but require the user to grip the weapon to the exclusion of any other action or function of the hand carrying or holding the weapon. The same is true of other handheld weaponry, e.g., maces, clubs, etc. When a person holding or carrying such a weapon wishes to use that hand for some other purpose, the weapon must be dropped or stowed before using the hand in some other manner.

Conversely, when the hand(s) are being used for some other purpose (e.g., firing a firearm) and access to a handheld bladed weapon is required, the combatant must release the firearm (or other article) and reach for, grip, and deploy the bladed weapon before being able to use it. Knives and similar handheld weaponry are generally stored within a pocket or perhaps an external sheath having a securing strap over the hilt of the weapon. In situations where split seconds are critical, the time required to release one weapon, tool, or article and then access, grip, and deploy another, e.g., a bladed weapon, can make the difference between victory and a fatally losing individual combat.

Thus a personal weapon solving the aforementioned problems is desired.

### SUMMARY OF THE INVENTION

The personal weapon comprises a plurality of selectively retractable and extendible blades placed across the upper palm and adjacent bases of the fingers of the hand. The device is installed on a glove (either fingerless or partially fingered), with blade extension occurring when the hand is opened with the fingers extended and blade retraction occurring when the fingers are closed over the palm. The device includes a base having a blade support pivotally extending therefrom, the blade support having a plurality of blades extending therefrom. The base includes a plurality of slots into which the blades fold when the fingers of the hand are closed over the palm. A base backing plate and blade support backing plate are installed within the glove to provide greater durability for the assembly.

A thumb-actuated safety mechanism selectively locks the blades in their retracted and stowed positions, or releases the blades for extension with the extension of the fingers. The device preferably extends only across the second, third, and fourth fingers, with the index finger remaining free to allow its use as a trigger finger for firing a firearm or for other uses independently of the opening or closure of the other fingers and corresponding operation of the blades of the device. If the personal weapon is required for close, hand-to-hand combat, the user may quickly transfer any other weapon to the other hand and deploy the blades of the personal weapon merely by releasing the safety and extending the fingers of the hand, a process that takes but a small fraction of a second.

These and other features of the present invention will become readily apparent upon further review of the following specification and drawings.

### BRIEF DESCRIPTION OF THE DRAWINGS

FIG. 1 is a perspective view of a personal weapon according to the present invention, with the glove to which it is attached shown oriented with the open palm outward.

FIG. 2 is a perspective view of the personal weapon of FIG. 1 having an orientation similar to that shown in FIG. 1, but with the fingers of the glove closed to retract the blades of the personal weapon.

FIG. 3 is an end elevation view of the personal weapon shown in FIG. 1, showing the extension of the blades with the fingers of the glove extended.

FIG. 4 is an end elevation view of the personal weapon shown in FIG. 2, showing the retraction of the blades with the fingers of the glove partially closed.

FIG. 5 is an exploded perspective view of the personal weapon showing the various components thereof, the glove being omitted for clarity in the drawing.

Similar reference characters denote corresponding features consistently throughout the attached drawings.

### DETAILED DESCRIPTION OF THE PREFERRED EMBODIMENTS

The present invention is a personal weapon, having a selectively retractable blade or blades that extend from a base, which is attached across the upper palm of the hand, i.e., adjacent the bases of the fingers. Extension of the blades is controlled by finger extension, with the blades extending as the fingers are extended and the hand opened, and retracting into the base when the fingers are closed over the palm.

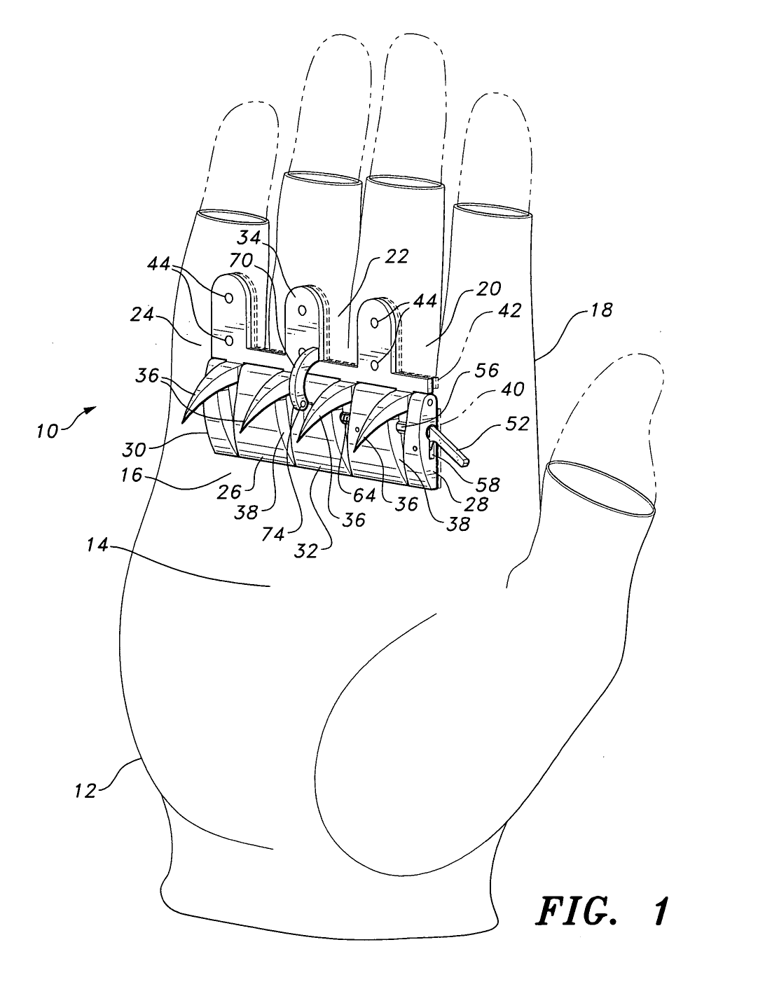

FIGS. 1 through 4 of the drawings illustrate the personal weapon 10 installed upon a partially fingered glove 12, leaving at least the distal phalanges uncovered. This allows direct tactile control of a rifle or handgun trigger by the distal phalanx of the index finger, precluding slippage. Alternatively, the glove may have complete, closed fingers, as shown in broken lines in FIGS. 1 through 4, or may be completely fingerless, but having a palm area extending over at least a portion of the proximal phalanges of the fingers in order to permit control of a hinge by the fingers and attachment of one plate of the hinge to a portion of the glove bearing against the fingers. The glove 12 includes at least a palm area 14 having an upper palm portion 16, i.e., that area of the palm across the pads of the palm and adjacent to the bases of the fingers. The base portions, respectively 18 through 24, of the index through fourth fingers extend flexibly from the upper palm portion 16 of the glove 12.

The personal weapon 10 includes a base 26 disposed across the upper palm portion 16 of the glove 12 (or hand, if secured directly thereto), with the base 26 having a thumb end 28, a distal end 30 opposite the thumb end, and a generally medial portion 32. A blade support 34 is pivotally attached to the base 26 by a hinge joint, and to the base portions 20 through 24 of the second through fourth fingers of the glove 12. The base 26 and blade support 34 are preferably somewhat shorter than the span of the hand, with the thumb end 28 of the base 26 and corresponding end of the blade support 34 stopping short of the index finger base portion 18. This allows the index finger base portion 18 of the glove 12 to remain free of the blade support 34 in order to allow independent movement of the index finger for use as a trigger finger, etc., without hindrance from, or obstruction by, the blade assembly.

The blade support 34 has at least one blade 36 extending therefrom, and preferably a plurality of such blades 36 extending in a row from the blade support 34, presenting the appearance of a claw. The blades 36 are formed as fixed, integral components with the blade support 34 and are substantially normal to the plane of the blade support 34, or perhaps angled slightly toward the base 26 when the hand is open as shown in FIGS. 1 and 3. Each of the blades 36 preferably has a reasonably heavy and thick base portion to provide sufficient strength, but the leading or cutting edges of the blades are quite sharp in order to provide the required effect, particularly those portions of the cutting edges toward the blade tips.

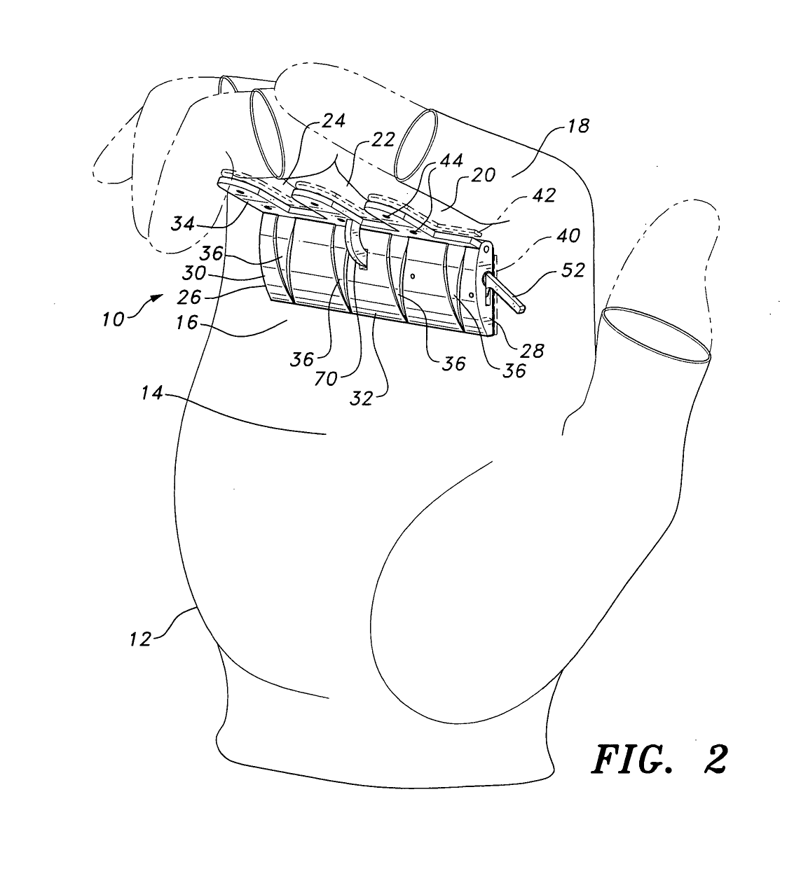

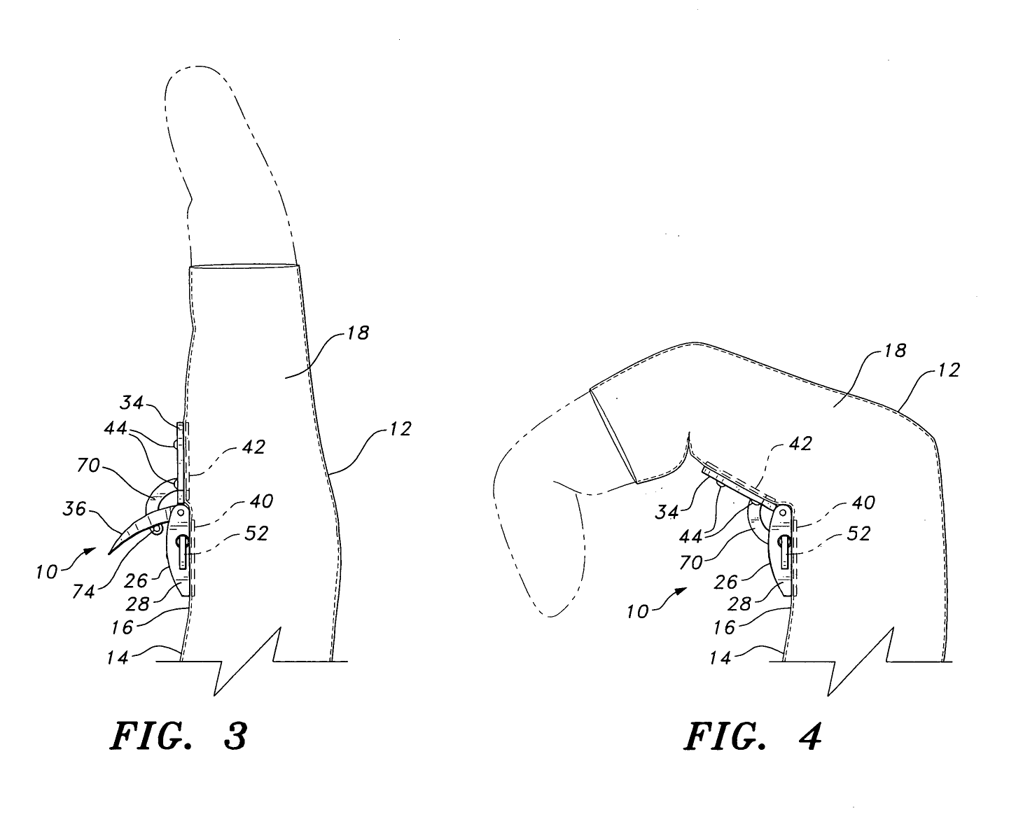

The base 26 preferably includes a plurality of blade retraction slots 38 formed therein, with the number of blade retraction slots 38 corresponding to the number of blades 36 and aligned with the blades. The sharpened leading or cutting edges of the blades 36 are thus nested or sheathed in their corresponding retraction slots 38 when the fingers are closed over the palm, generally as shown in FIGS. 2 and 4; somewhat similar to the configuration of a pocket knife blade when folded.

FIGS. 1 and 3 illustrate the personal weapon 10 in its deployed configuration when the fingers of the hand are opened and the hand is extended or substantially flat, with FIGS. 2 and 4 showing the retraction or folding of the blades 36 into their corresponding retraction slots 38 when the hand is flexed or closed. As the bases 18 through 24 of the fingers are folded or closed toward the palm 14, the blade support 34 is correspondingly pivoted or folded toward the base 26. This results in the blades 36, which are rigidly affixed to the blade support 34, folding or pivoting toward the base 26 until they are nested within their corresponding retraction slots 38 in the base 26 when the hand is substantially closed.

FIGS. 1-4 also show the addition of a base backing plate 40 and a blade support backing plate 42 installed within the glove 12, i.e., opposite their respective base 26 and blade support 34 components. These two backing plates 40 and 42 provide a much stronger attachment for the base 26 and blade support 34 to the glove 12, by sandwiching the upper, palm portion 16 of the glove 12 between the base 26 and its backing plate 40 and sandwiching the second through fourth finger base portions 20 through 24 between the blade support 34 and its backing plate 42. A plurality of rivets 44 may be used to secure the base 26 and blade support 34 to their respective backing plates 40 and 42. Alternatively, straps or other suitable removable attachment means could be used to secure the base 26 and pivotally attached blade support 34 to the user's hand, if so desired.

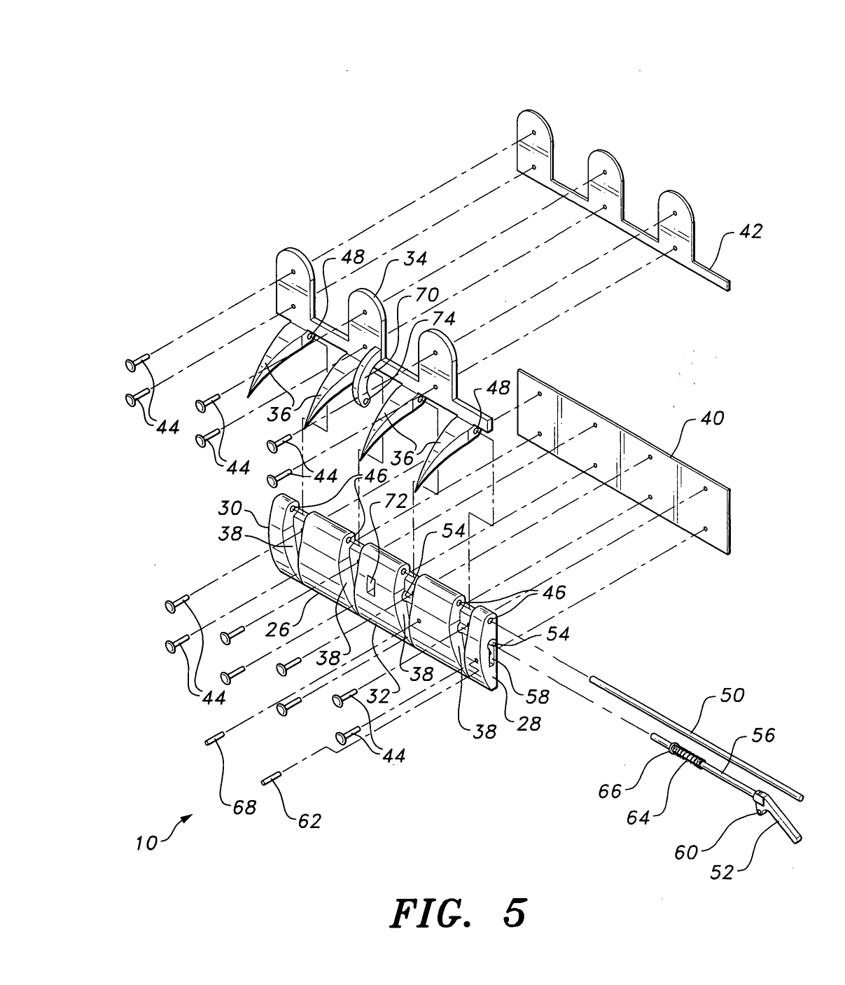

FIG. 5 of the drawings provides an exploded perspective view of the various components of the personal weapon 10, including the hinge attachment mechanism between the base 26 and the blade support 34. The base 26 includes a hinge pin passage 46 therethrough, with the blade support 34 having a corresponding hinge pin passage 48 therethrough, along the bases of the blades 36. A hinge pin 50 extends through the coaxially aligned hinge pin passages 46 and 48 when the base 26 and blade support 34 are assembled to one another, so that the base 26 and the blade support 34 form hinge plates.

A safety mechanism is also provided to secure the blades 36 in their corresponding retraction slots 38 in the base 26 when desired. This safety mechanism is operated by a safety lever 52, which extends from the thumb end 28 of the base 26 where it is easily manipulated by the thumb of the user of the weapon 10. A safety rod passage 54 extends through the base 26 from the thumb end 28 to at least the medial portion 32 and substantially parallel to the hinge pin passage 46, with a safety rod 56 installed in the safety rod passage 54. The safety rod 56 is actuated axially in its passage 54 by manipulation of the safety lever 52.

The safety lever 52 is secured in a slot 58 in the thumb end 28 of the base 26 by an off-center lug 60 having a pin 62 therethrough, with the safety rod 56 being pivotally secured to the safety lever 52. Thus, when the safety lever 52 is manipulated to move the lever 52 toward its slot 58 in the thumb end 28 of the base 26, the safety lever 52 withdraws the safety rod 56 slightly from its safety rod passage 54. A spring 64 is compressed between a stop 66 installed upon the safety rod 56 and a spring retaining pin 68 installed through one side of the safety rod passage 54, with spring compression urging the safety rod 56 further into its passage 54 unless withdrawn by manipulation of the safety lever 52.

A safety latch 70 extends from the blade support 34 and is aligned with a safety latch passage 72, which extends through the medial portion 32 of the base 26 and communicates with the medial portion or end of the safety rod passage 54. The distal end of the safety latch 70 extends through the safety latch passage 72 of the base 26 and into the medial portion or end of the safety rod passage 54 when the blade support 34 is folded or hinged toward the base 26 to retract the blades 36 into their slots 38.

The distal end of the safety latch 70 includes a safety rod passage 74 therethrough, which aligns coaxially with the safety rod passage 54 of the base 26 and its safety rod 56 when the blades 36 are folded into their slots 38, as shown in FIGS. 2 and 4.

It will be seen that this safety mechanism locks the blades 36 in their retracted configuration when the distal end of the safety rod 56 engages the safety rod passage 74 of the safety latch 70 when the latch 70 is positioned within the safety latch passage 72 of the base 26. The compression of the spring 64 holds the safety rod 56 in its engagement with the safety rod passage 74 of the safety latch 70, unless the safety lever 52 is deliberately manipulated to withdraw the end of the safety rod 56 from the passage 74 through the end of the safety latch 70. However, when a person wearing the personal weapon 10 needs to deploy the blades 36, it is only necessary to toggle the safety lever downwardly, i.e., toward the thumb end 28 of the base 26, to withdraw the end of the safety rod 56 from the passage 74 of the safety latch 70. The user may then extend the fingers to open the hand, thereby extending the blade support 34 to at least a generally coplanar orientation with the base 26 and extending the blades 36 to a combat ready orientation.

It will be noted that the blade support 34 and its corresponding backing plate 42 are not rectangular, but have a base bar from which three spaced apart fingers (or lobes or projections) extend, corresponding to the proximal phalanges of the second through fourth fingers. When the blades 36 are extended, the weapon 10 has the appearance of a claw, but with the talons extending from the palm instead of the fingers. The blades 36 may be used with a raking motion, and are sharp enough to tear the flesh. The glove 12 is made from a material strong enough that the glove will not tear when used in this manner, and engages the hand snugly so that the glove 12 does not slide off the hand when used as a weapon.

In conclusion, the personal weapon enables the wearer or user to respond to a hand-to-hand combat threat or situation much more rapidly than when using a separate handheld weapon, e.g., a knife, etc. The weapon is already in hand, literally and figuratively, thereby eliminating the step of reaching for and grasping a separate weapon. It should be noted that while the personal weapon is illustrated as a right-hand glove configuration in the accompanying drawings, it will be seen that construction of the device for use on the left hand or with a left-hand glove is merely a matter of forming the components in mirror image to those illustrated in the accompanying drawings. Accordingly, the personal weapon may be used by virtually anyone possessing any hand-to-hand combat skills.

It is to be understood that the present invention is not limited to the embodiments described above, but encompasses any and all embodiments within the scope of the following claims.

We claim:

1. A personal weapon deployed on a palmar surface of a user's hand, comprising:
a glove having a palm, at least a portion of the glove being adapted to cover at least a portion of the proximal phalanges of the fingers; and
a blade assembly extending across the glove at an upper portion of the palm, the blade assembly having:
a base defining a plurality of sheathes;
a blade support pivotally attached to the base; and
a plurality of blades extending from the blade support, the blade assembly pivoting between an extended position deploying the blades substantially normal to the palm of the glove when the glove is opened to extend the hand and a retracted position sheathing the blades within the base when the glove is flexed to close the palm.

2. The personal weapon according to claim 1, wherein:
the base further includes a thumb end, a distal end opposite the thumb end, and a medial portion; and
a selectively operable safety lever is pivotally attached to and extends from the thumb end of the base, locking the at least one blade in a retracted configuration in the base when actuated.

3. The personal weapon according to claim 2, wherein:
the base further includes a safety rod passage disposed therethrough from the thumb end thereof to at least the medial portion thereof, and a safety latch passage disposed in the medial portion thereof and communicating with the safety rod passage;
a safety rod is pivotally attached to and extends from the safety lever, and extends through the safety rod passage of the base;
the blade support is attached to the proximal phalanges of the fingers of the glove and hingedly attached to the base, the plurality of blades extending from the blade support substantially normal thereto; and
a safety latch extends from the blade support and is aligned with the safety latch passage of the base, the safety latch further including a safety rod passage disposed therethrough; whereby
the safety rod engages the safety rod passage of the safety latch when the plurality of blades is retracted against the base and the safety lever is adjusted to a safety position, thereby locking the plurality of blades against the base and precluding extension thereof.

4. The personal weapon according to claim 1, further comprising:
a base backing plate disposed within the glove opposite the base, the upper palm portion of the glove being sandwiched between the base and the base backing plate; and
a blade support backing plate disposed within the glove opposite the blade support, the portion of the glove covering the proximal phalanges of the fingers being sandwiched between the blade support and the blade support backing plate.

5. A personal weapon, comprising:
a glove having a palm;
a blade assembly extending laterally across the palm of the glove, the blade assembly having a plurality of blades, the blade assembly pivoting about a lateral axis to expose the blades for use as a weapon when the glove is extended and to retract the blades to sheathe the blades when the glove is flexed; and
a selectively operable safety lever pivotally attached to and extending from the blade assembly, the lever being movable to a locked position to selectively lock the blades in a retracted position.

6. The personal weapon according to claim 5, wherein:
the glove further includes at least an upper palm portion with index and second through fourth proximal phalange portions flexibly extending from the upper palm portion;
a base is attached to the upper palm portion of the glove; and
a blade support is attached to the index and second through fourth proximal phalange portions of the glove.

7. The personal weapon according to claim 6, wherein:
the base further includes a thumb end, a distal end opposite the thumb end, and a medial portion; and
the safety lever is pivotally attached to and extends from the thumb end of the base, locking the at least one blade in a retracted configuration in the base when actuated.

8. The personal weapon according to claim 7, wherein:
the base further includes a safety rod passage disposed therethrough from the thumb end thereof to at least the medial portion thereof, and a safety latch passage disposed in the medial portion thereof and communicating with the safety rod passage;
a safety rod is pivotally attached to and extends from the safety lever, and extends through the safety rod passage of the base;
the blade support is hingedly attached to the base, the plurality of blades extending from the blade support substantially normal thereto; and
a safety latch extending from the blade support and aligned with the safety latch passage of the base, the safety latch further including a safety rod passage disposed therethrough; whereby
the safety rod extends through the safety rod passage of the base and engages the safety rod passage of the safety latch when the plurality of is blades is retracted against the base and the safety lever is adjusted to a safety position, thereby locking the plurality of blades against the base and precluding extension thereof.

9. The personal weapon according to claim 6, wherein the base further includes a plurality of blade retraction slots disposed therein and aligned with corresponding ones of the plurality of blades.

10. The personal weapon according to claim 6, further comprising:
a base backing plate disposed within the glove opposite the base, the upper palm portion of the glove being sandwiched between the base and the base backing plate; and
a blade support backing plate disposed within the glove opposite the blade support, the portion of the glove covering the proximal phalanges of the fingers being sandwiched between the blade support and the blade support backing plate.
